(19) United States
(12) Patent Application Publication
(10) Pub. No.: US 2015/0186009 A1
(43) Pub. Date: Jul. 2, 2015

(54) ELECTRONIC DEVICE, METHOD AND STORAGE MEDIUM

(71) Applicants: Kabushiki Kaisha Toshiba, Tokyo (JP); Toshiba Lifestyle Products & Services Corporation, Tokyo (JP)

(72) Inventor: Hayato Nishimura, Tokyo (JP)

(21) Appl. No.: 14/471,464

(22) Filed: Aug. 28, 2014

(30) Foreign Application Priority Data
Dec. 26, 2013 (JP) 2013-268970

(51) Int. Cl. G06F 3/0481

(52) U.S. Cl. CPC G06F 3/04817

(57) ABSTRACT

According to one embodiment, an electronic device capable of activating applications and displaying the applications in a multi-window mode, includes a memory, a controller, and a display. The memory stores a history of the applications displayed in the multi-window mode. The controller activates a first application and a second application based on the history stored in the memory, upon receiving an activation trigger. The display configured to display windows for the first and second applications in a first area and a second area obtained by dividing a screen.

### CROSS-REFERENCE TO RELATED APPLICATIONS

This application is based upon and claims the benefit of priority from prior Japanese Patent Application No. 2013-268970, filed Dec. 26, 2013, the entire contents of which are incorporated herein by reference.

### FIELD

Embodiments described herein relate generally to an electronic device capable of simultaneously activating applications, and a method and a storage medium employed in the device.

### BACKGROUND

For instance, some types of conventional portable electronic devices, such as PCs, tablet terminals and smartphones, employ a multi-window mode. Plural applications are simultaneously activated and plural windows corresponding to the respective applications are synthesized and displayed in one screen. To operate the devices in the multi-window mode, a particular activation trigger activates a multi-window launcher for realizing a multi-window display. Upon activation of the multi-window launcher, the screen is divided into two areas. If desired two applications are selected from an application list, windows for the respective applications are displayed in the respective two areas of the screen. Thus, a user must perform two operations for selecting desired applications, after executing a particular activation trigger to set the multi-window mode.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view of an electronic device according to an embodiment.

FIG. 2 is an exemplary block diagram showing a structure of the electronic device of the embodiment.

FIG. 3 is an exemplary flowchart showing a multi-window mode for the electronic device of the embodiment.

FIG. 4 is an exemplary flowchart showing a multi-window mode for the electronic device of the embodiment.

FIGS. 5A, 5B, 5C, and 5D show examples of screen transition in the multi-window mode for the electronic device of the embodiment.

FIGS. 6A and 6B show other examples of screen transition in the multi-window mode for the electronic device of the embodiment.

FIGS. 7A, 7B, 7C, 7D, 7E, 7F, 7G, 7H, 71, 7J, 7K, and 7L shows examples of operation-right indicators displayed in the multi-window mode by the electronic device of the embodiment.

FIG. 8 is an exemplary flowchart showing a multi-window mode for the electronic device of the embodiment.

FIGS. 9A, 9B, 9C, 9D, 9E, and 9F show examples of screen transition in the multi-window mode for the electronic device of the embodiment.

FIG. 10 shows another example of the electronic device of the embodiment.

### DETAILED DESCRIPTION

An embodiment will be described with reference to the accompanying drawings.

In general, according to one embodiment, an electronic device capable of activating applications and displaying the applications in a multi-window mode, includes a memory, a controller, and a display. The memory is configured to store a history of the applications displayed in the multi-window mode. The controller is configured to activate a first application and a second application based on the history stored in the memory, upon receiving an activation trigger. The display is configured to display windows for the first and second applications in a first area and a second area of a screen.

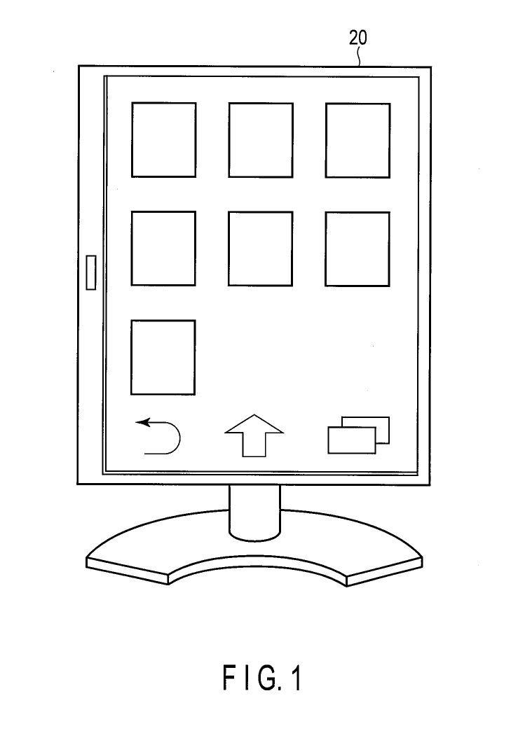

FIG. 1 shows an example of an electronic device according to the embodiment. The electronic device is realized as, for example, a large touch-panel monitor device 20 of, for example, 30 inches. The monitor device 20 may be a device for displaying the output image of a portable electronic device, such as a smartphone or a tablet, or may have the same function as the portable electronic device but have a large display portion of a stationary-type. The touch screen display of the electronic device can rotate through 90 degrees, and can be used in both a landscape mode and a portrait mode. The touch screen display incorporates a flat panel display, and a sensor configured to detect the touch position of a finger or a stylus on the screen (actually, the coordinates of the typical point of a touch surface with a certain size, or the region of the touch surface). The flat panel display may be, for example, a liquid crystal display (LCD). As the sensor, a touch panel of an electrostatic capacitance type can be used, for example. The touch panel is provided to cover the screen of the flat panel display. The touch panel can detect a touch operation performed on the screen using a finger or a stylus. The touch operation is, for example, a tap operation, a double tap operation, a swipe operation, etc.

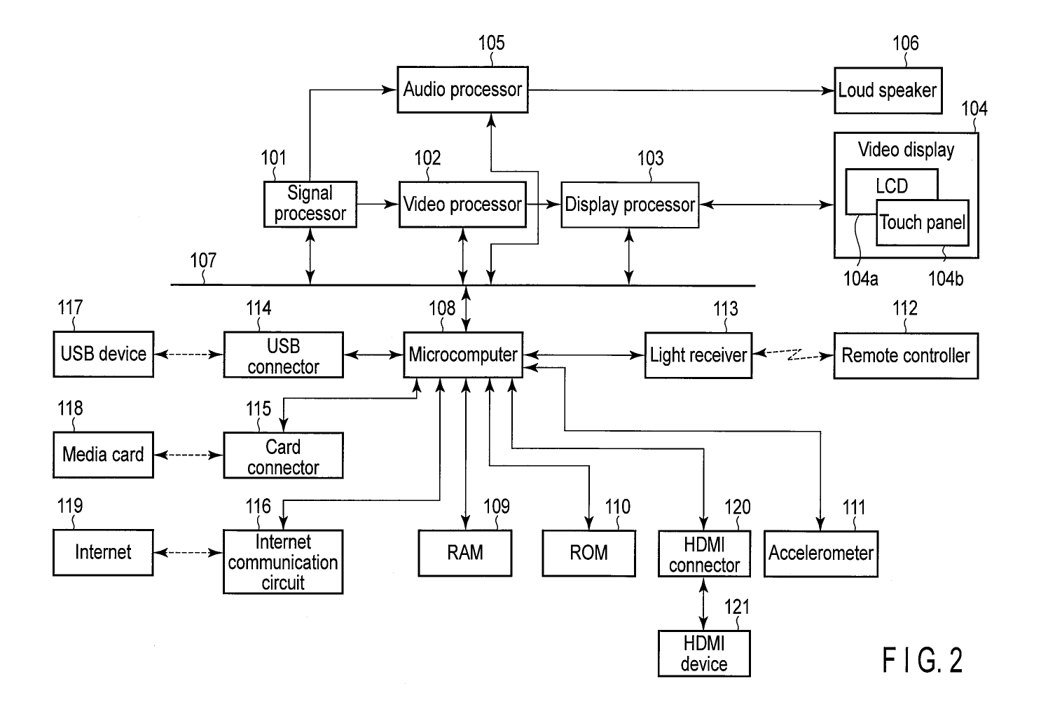

FIG. 2 shows the system configuration of the monitor device 20. A signal processor 101 processes various types of digital signals. A video signal output from the signal processor 101 is adjusted to a correct screen size by a video processor 102, and is subjected to a display processor 103, where it is superposed on graphic data, such as character information, in a display processor 103, and is then displayed on a video display 104. As mentioned above, the video display 104 incorporates an LCD 104a and a touch panel 104b. Further, the audio signal output from the signal processor 101 is subjected to acoustic processing and amplification in an audio processor 105, and is output as a sound through a loud speaker 106.

The signal processor 101, the video processor 102, the display processor 103 and the audio processor 105 exchange signals and data under the control of a microcomputer 108 via a communication line 107, such as an I2C bus. The microcomputer 108 is also connected to a RAM 109, a ROM 110, an accelerometer 111, and a light receiver 113 for receiving signals from the remote controller 112, which exchange signals and data therebetween. The microcomputer 108 is further connected to a USB connector 114, a card connector 115, an Internet communication circuit 116, and an HDMI (trademark) connector 120, whereby the microcomputer 108 can externally read moving images, photographs, music data, etc., via a USB device (an HDD, an ODD, etc.) 117, a media card 118, the Internet 119 and an HDMI device 121. The HDMI device 121 may be a portable electronic device, such as a smartphone or a tablet. The USB device 117 includes an input device, such as a keyboard and a mouse. As a result, character input can be performed using an external hardware keyboard, instead of a software keyboard on the touch panel. Further, the microcomputer 108 can browse web content via the Internet 119. The accelerometer 111 is formed of hall elements for detecting, for example, earth magnetism. More specifically, the hall elements are three elements corresponding to the X-, Y- and Z-axes and capable of the angles of these three axes. In accordance with the angle detection, the mode is switched between the portrait mode and the landscape mode.

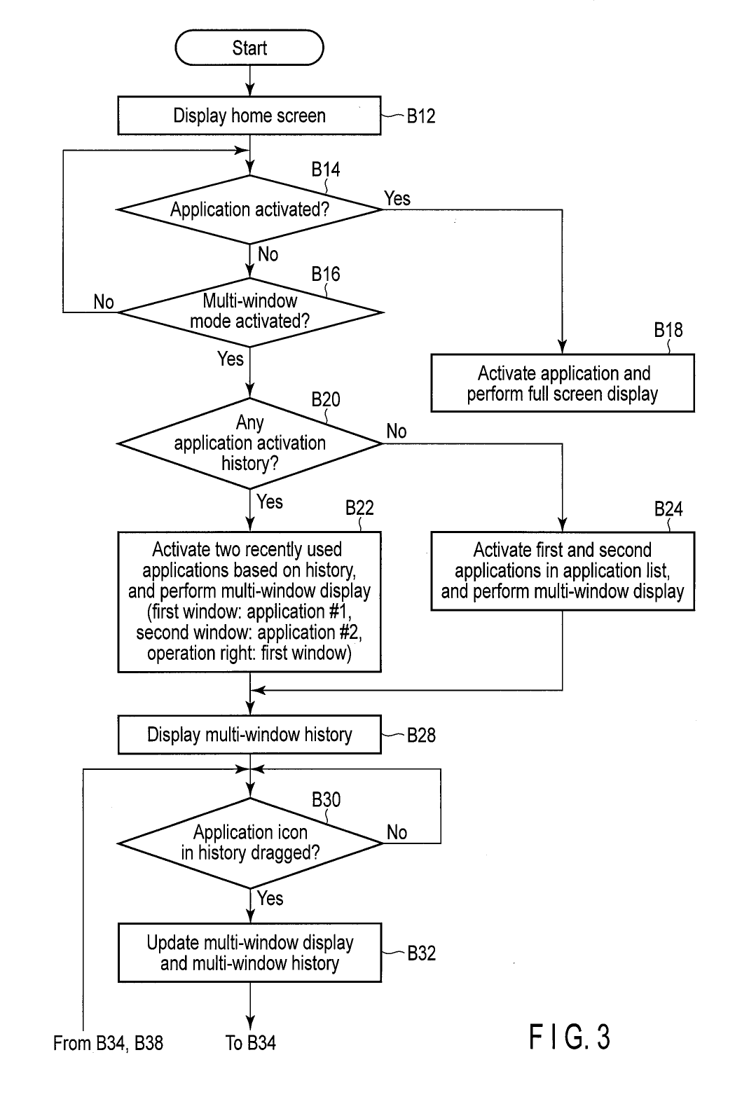

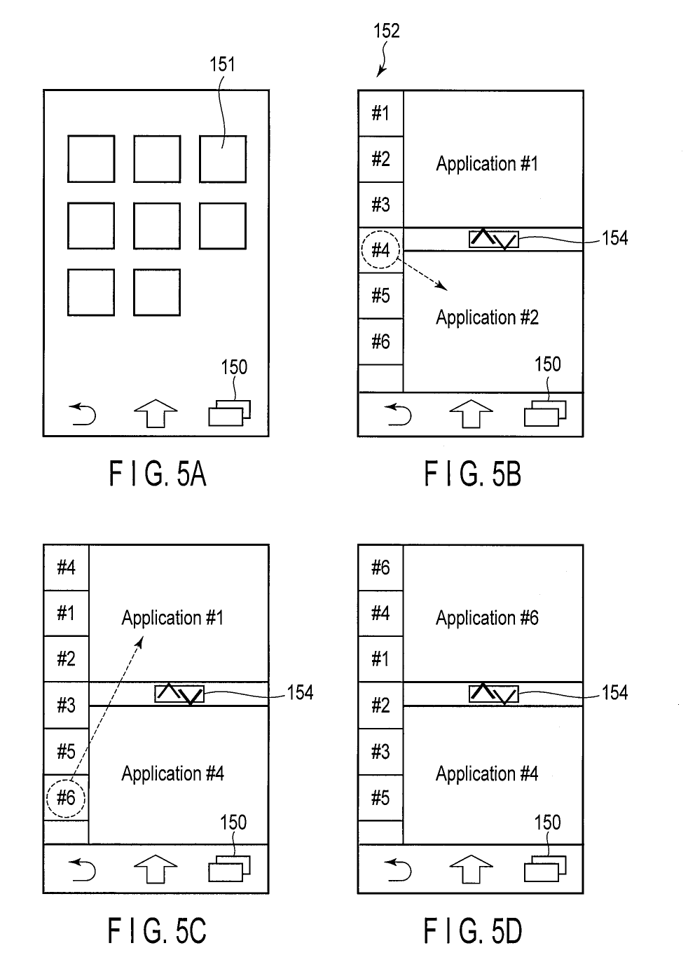

Referring now to FIGS. 3, 4, 5A, 5B, 5C, 5D, 6A, and 6B, a description will be given of an example of an operation performed when a multi-window mode is raised from the home screen. Upon turning on the monitor device, the home screen is displayed in block B12 in FIG. 3. As shown in FIG. 5A, the home screen includes a plurality of icons 151. By tapping an application icon 151, the corresponding application is activated. In block B14, it is determined whether activation of an application has been instructed. If it is determined that activation of an application has been instructed, the application is activated in block B18, thereby performing full-screen display.

Below the home screen, a back key, a home key and a recent key 150 are always displayed. If the back key is tapped, the screen is back to the preceding one. If the home key is tapped, the screen is back to the home screen. If the recent key 150 is tapped, a “history of recently used applications” is displayed. If the recent key 150 is touched long (a touch of two or more seconds is made), a multi-window mode is launched (activated).

When no application is activated, i.e., when the home screen is displayed, it is determined whether the activation of the multi-window mode has been instructed in block B16. If the activation of the multi-window mode has been instructed, it is determined in block B20 whether there is a “history of applications recently used.” The “history of applications recently used” is held even after the power supply is turned off. However, the history may be cleared when the power supply is turned off. If there is no “history of applications recently used,” first and second applications in a list of applications (a list called, for example, a drawer) arranged in a preset order irrespective of the activation history are activated, thereby performing a multi-window display in block B24. In contrast, if there is a “history of applications recently used,” an application (first application) of the newest activation time and the second newest application (second application) are activated in block B22 based on the history, thereby performing a multi-window display.

In the multi-window display, windows of the first and second applications are displayed in first and second areas obtained by vertically or horizontally bisecting the screen, respectively. A right of operation is assigned to only one of the first and second application windows. In the initial state of the multi-window display, a right of operation is assigned only to the first application window. In an electronic device where a cursor is displayed, and is moved by a mouse, and a function is determined or selected by clicking the mouse, if the cursor is positioned in a window with no operation right, it does not move even if the mouse is operated. In order to move the cursor in the window with no operation right, it is necessary to perform another operation for moving the operation right. In the device with a touch panel, this problem will not occur superficially if the device is set so that the operation right will move by touching.

After blocks B22 and B24, a multi-window history 152 is displayed in the left end portion of the screen in block B28, as shown in FIG. 5B. In the “history of applications recently used” displayed when the recent key 150 is tapped, the recently used applications are arranged in the order of activation time, regardless of whether each application is an application (single-window application) used in the full-screen display or an application (multi-window application) used in the multi-window display. In contrast, the multi-window history 152 is a history of only multi-window applications and excludes single-window applications. Since in this case, the first and second applications are displayed, in a multi-window mode, the newest application in the multi-window history 152 is the first application, and the second newest application is the second application. The third newest, et seq. applications are those activated in the past.

If at least one of the two applications activated in block B22 based on the “history of applications recently used” is an application whose activation is not desired now, it can be replaced with another. More specifically, it is sufficient if the icon of a desired application in the multi-window history 152 is swiped into the window of the application whose activation is not desired.

Since the multi-window history 152 excludes the applications having being activated in the single-window mode and includes only the applications having being activated in the multi-window mode, if the included applications are displayed as candidates for applications to be activated in the multi-window mode, selection of a multi-window application is facilitated. For instance, if a user wishes to use a fourth application in the multi-window mode, instead of the second application, they swipe the icon of the fourth application into the window of the second application as shown in FIG. 5B (block B30). At this time, the first and fourth applications are displayed in the upper and lower windows, respectively, as shown in FIG. 5C. Thus, the multi-window history is updated (block B32). When a new application has been activated, a right of operation is assigned to the window of the new application.

Similarly, when the user wishes to activate a sixth application instead of the first application, they swipe the icon of the sixth application into the window of the first application as shown in FIG. 5C (block B30). At this time, the sixth and fourth applications are displayed in the upper and lower windows, respectively, as shown in FIG. 5D. Thus, the multi-window history is updated (block B32). When a new application has been activated, a right of operation is assigned to the window of the new application. Further, the multi-window history 152 is automatically turned off after a predetermined period elapses, or is turned off by a particular operation (e.g., by double-clicking the history 152).

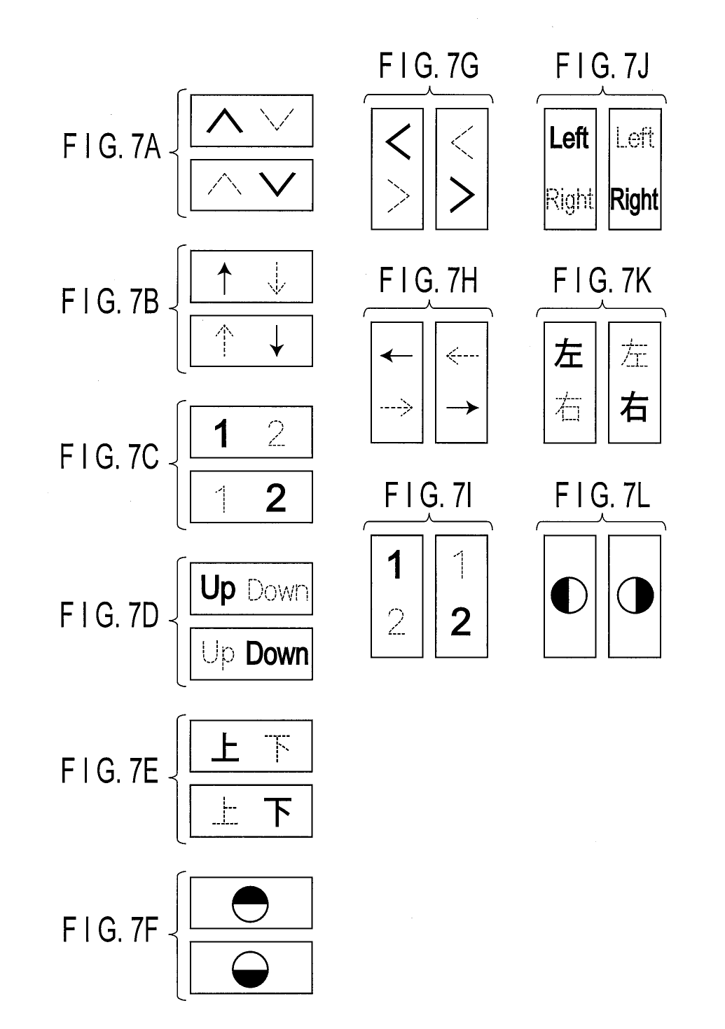

In the multi-window display, a horizontal bar is displayed between the two windows. An operation right indicator 154 is displayed on the central portion of the horizontal bar. The operation right indicator 154 incorporates a pair of arrowhead marks “ [symbol] ” and “ [symbol] ,” the left mark “ [symbol] ” indicating the upper window, the right mark “ [symbol] ” indicating the lower window (see FIG. 7A). The arrowhead mark indicating the window with an operation right is highlighted, while the arrowhead mark indicating the window with no operation right is non-highlighted. Specifically, in FIG. 5B, the left arrowhead mark “ [symbol] ” is highlighted, in FIG. 5C, the right arrowhead mark “ [symbol] ” is highlighted, and in FIG. 5D, the left arrowhead mark “ [symbol] ” is highlighted. As the highlighted/non-highlighted display, thick-line/thin-line display, lighting ON/OFF display, bright-color/dark-color display, high-luminance/low-luminance display, blink/normal display, etc., can be employed. Thus, in order to make it easy to understand that one of the displayed icons corresponding to the upper and lower screens indicates a currently operated screen having an operation right, the one icon is changed in the way of display from the other.

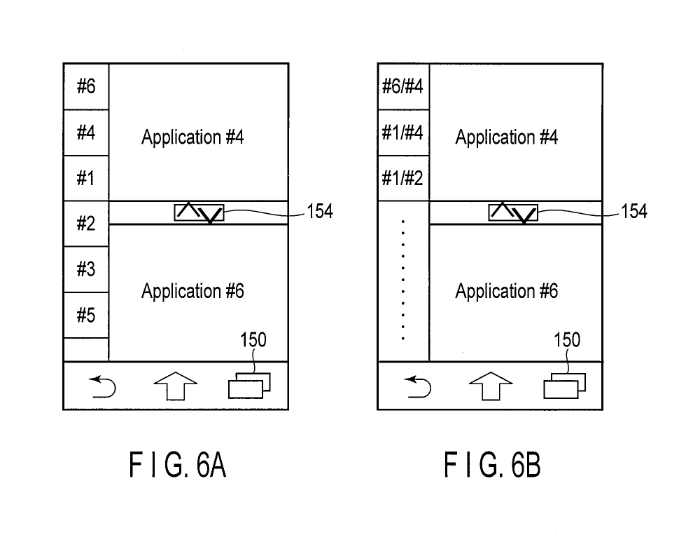

If the indicator is formed of a single arrowhead and is configured to change the direction of the arrowhead in accordance with the window with the operation right, it is difficult for the user to confirm the direction of the arrowhead since the horizontal bar has a narrow width as shown in FIGS. 5A, 5B, 5C, 5D, 6A, and 6B. Further, the expression using only one arrow may cause the user to wrongly think that the icon is used to move the area. Thus, it is difficult to detect what is indicated by the indicator. In view of this, in the embodiment, a pair of icons, the left one of which indicates the upper window and the right one of which indicates the lower window, are arranged such that one of the right and left icons is highlighted. The highlighted display of one of the right and left icons can be more easily detected than the display of direction of the arrowhead. Once the highlighted icon is detected, it can be understood which window has an operation right, from its position. Thus, even the indicator positioned in a narrow horizontal bar enables the user to easily determine which one of the upper and lower windows has the operation right.

FIGS. 7A, 7B, 7C, 7D, 7E, 7F, 7G, 7H, 71, 7J, 7K, and 7L shows other examples of the operation-right indicator. Further, the shape of the icon is not limited to the arrowhead. It is sufficient if the icon expresses the state of display on the screen and enables the user to understand which one has the operation right. FIG. 7B shows arrows used instead of the arrowheads. FIG. 7C shows numbers “1” and “2” indicating the first (e.g., upper) window and the second (e.g., lower) window, respectively. FIG. 7D shows characters “Up” and “Down” indicating the upper and lower windows, respectively. FIG. 7E shows Chinese characters which called “ue” (meaning “Up”) and “shita” (meaning “Down”) indicating the upper and lower windows, respectively. Furthermore, the number of icons is not limited to 2, but may be 1. It is sufficient if change is understandable from the icon(s). For instance, FIG. 7F shows a case where the upper semicircle (it may be a circle or a rectangle) of the icon indicates ON lighting, and the lower semicircle (circle or rectangle) of the icon indicates OFF lighting. The icon having its upper half lighted indicates the upper window, and the icon having its lower half lighted indicates the lower window.

If the monitor device is rotated through 90 degrees and assumes a landscape mode, the first and second windows are displayed in the left and right screen areas, respectively, and a vertical bar is displayed in the central portion of the screen. FIGS. 7G to 7L show examples of the operation-right indicators when the indicator is used in the landscape mode. FIG. 7G corresponds to FIG. 7A, FIG. 7H corresponds to FIG. 7B, FIG. 7I corresponds to FIG. 7C, FIG. 7J corresponds to FIG. 7D, FIG. 7K corresponds to FIG. 7E, and FIG. 7L corresponds to FIG. 7F. Since the screen is rotated through 90 degrees, Up/Down are shifted to Left/Right, Chinese characters which called “ue”/“shita” are shifted to Chinese characters which called “hidari”/“migi”, Upper-half/Lower-half of a circle or rectangle are shifted to the left-half/right-half of the same.

Although the horizontal bar is positioned in the central portion of the screen in the initial state, its position can be moved by a swiping operation when necessary. Further, the first window can be set greater or smaller than the second window. If the user wishes to change the first and second windows set to different sizes, they can easily realize this by changing the windows instead of moving the horizontal bar. In this embodiment, the operation-right indicator 154 also serves as a window switch instruction button. By thus using, as one part, the pair of icons indicating the upper and lower screens, the operation-right indicator 154 can also be used as a trigger for a swap function of exchanging the upper and lower screens, thereby enhancing the operability.

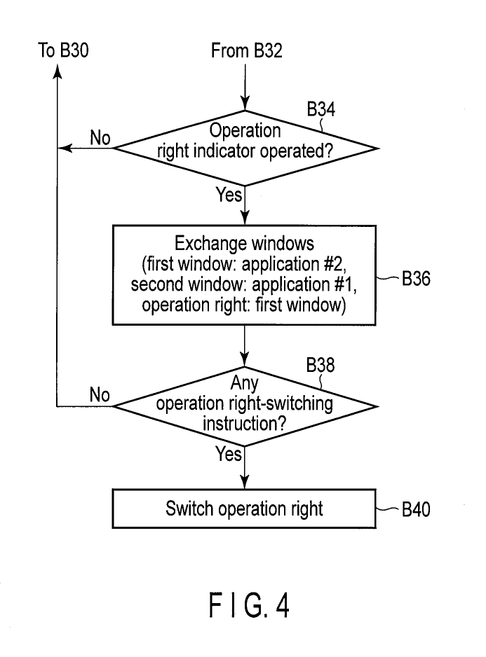

Referring back to FIG. 4, it is determined in block B34 whether the operation-right indicator 154 has been operated. When the operation-right indicator 154 has been operated, window exchange is performed in block B36. Namely, if the operation-right indicator 154 has been tapped in the state shown in FIG. 5D, the fourth and sixth application windows are displayed in the upper and lower areas, respectively, as shown in FIG. 6A.

The operation-right indicator 154 also serves as the window switch instruction button, but does not serve as an operation-right switch instruction button. In this stage, operation right switching is not yet performed. To perform operation right switching, another operation is needed. In view of this, it is determined in block B38 whether there is an operation right-switching instruction. If the operation right-switching instruction exists, operation right switching is performed in block B40. The operation-right indicator 154 updates its display. Namely, in FIG. 5D, the left-handed upward arrowhead is highlighted, while in FIG. 6A, the right-handed downward arrowhead is highlighted.

As described above, if the recent key 150 has been pressed long in an arbitrary screen, the two recently used applications are automatically activated based on the activation history of applications, and displayed in a multi-window mode. Further, since the history of the applications used in the multi-window mode is displayed, if the user wishes to activate an application other than the automatically activated applications, it is sufficient if they select the icon corresponding to this application from the history and swipe it into the window in which they wish to display the application. Thus, they can easily change the applications to be used in the multi-window mode.

In the multi-window history 152, the applications having being activated in the multi-window mode are arranged in the order of activation. In this case, the order of arrangement may be modified as shown in FIG. 6B such that pairs of applications having being activated in the multi-window mode are arranged in the order of activation.

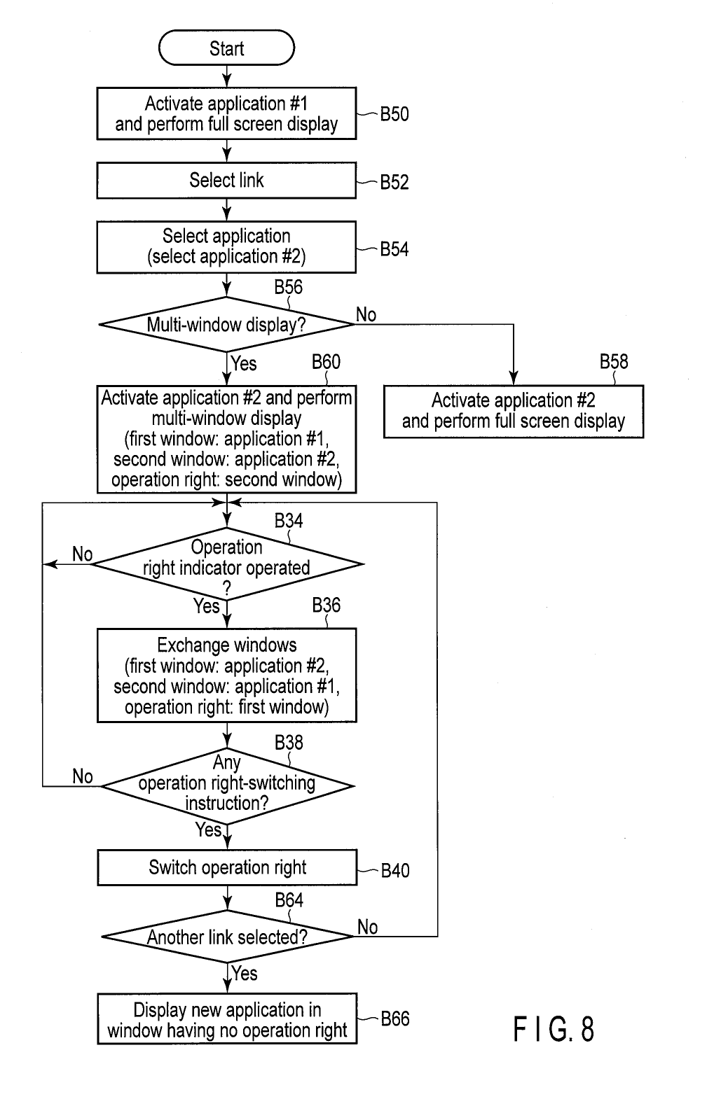

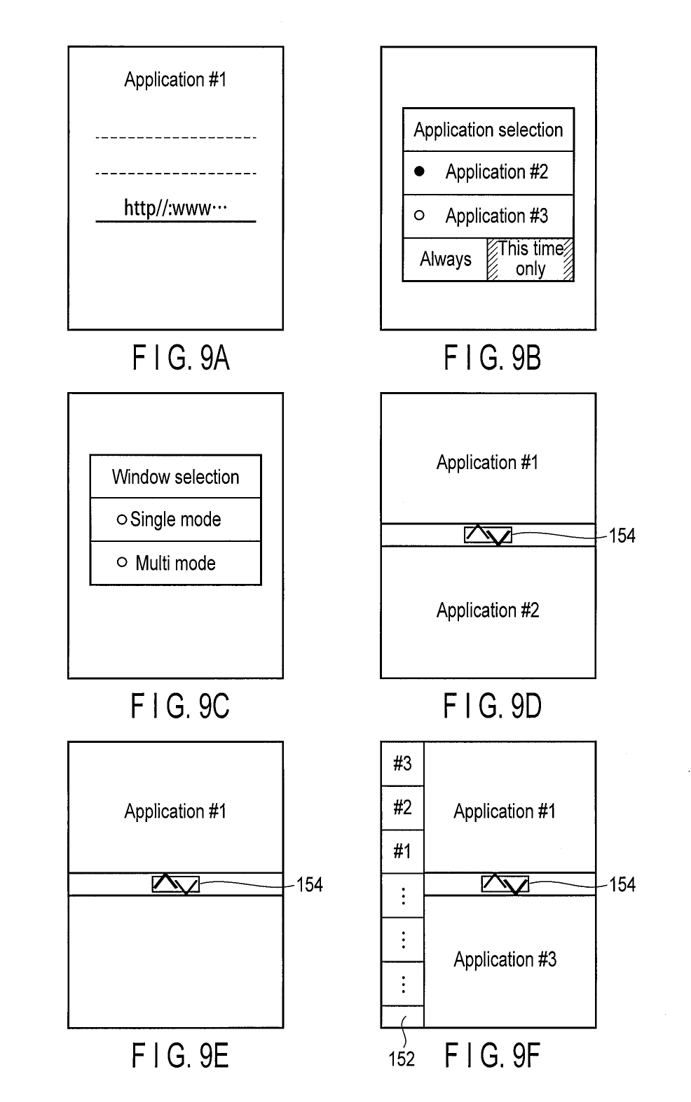

Referring then to FIGS. 8, 9A, 9B, 9C, 9D, 9E, and 9F, a description will be given of an example of an operation for launching (activating) an application in the multi-window mode during the activation of another application. When the power supply for the monitor device has been turned on and an application icon has been tapped in the home screen, the corresponding first application is activated in block B50, thereby performing a full-screen display as shown in FIG. 9A. In this state, if an operation (e.g., selection of a link) for launching another application has been performed (block B52), a selection screen for selecting to-be-linked applications in block B54, as is shown in FIG. 9B is displayed. Assume here that a second application has been selected “only this time.” If “always” is once selected in association with the to-be-linked applications, the selection screen shown in FIG. 9B is skipped.

In block B56, a selection screen as shown in FIG. 9C, used to determine whether a multi-window display should be performed, is displayed. The user can beforehand set whether this selection screen should be displayed. If the user has beforehand set not to display the selection screen, the selection screen shown in FIG. 9C is also skipped. In this case, the multi-window display is always performed. If the multi-window display is not selected, a second application is activated in block B58, whereby the second application is displayed by a full-screen display, instead of the first application. Since the full-screen display performed at this time is similar to that shown in FIG. 9A, it is not shown.

When the multi-window display has been selected, the second application is activated in block B60, whereby the first and second applications are displayed in the first and second areas as shown in FIG. 9D, respectively. Since the activation time of the second application is later than that of the first application, the operation right is assigned to the second application window. At this time, in the operation-right indicator 154, the downward arrowhead “ [symbol] ” is highlighted.

In block B34, it is determined whether the operation-right indicator 154 has been operated. If it is determined that the operation-right indicator 154 has been operated, window exchange is performed in block B36. In block B38, it is determined whether there is an operation right-switching instruction. If the operation right-switching instruction exists, the operation right is switched in block B40.

If an operation (e.g., selection of another link) for launching another application has been performed with the operation right assigned to the first application in block B64, the program returns to block B34, where such a selection screen for linked applications as shown in FIG. 9B is displayed, thereby repeating the subsequent operations. When a third application has been selected, a third application window is displayed instead of the second application window in block B66, as is shown in FIG. 9F. Thus, the first and third application windows are displayed in the multi-window mode.

Even when multi-window display is performed by link selection, a multi-window history may be displayed as shown in FIG. 6B, thereby exchanging the applications displayed in the multi-window mode.

As described above, when a second application has been activated during the display (single-window display) of a first application, display is automatically switched from the single-window display to the multi-window display to enable first and second application windows to be displayed simultaneously. When an operation for launching the second application has been executed, a screen for enabling the user to select whether display should be switched from the single-window display to the multi-window display may be displayed, instead of automatic switching from the single-window display to the multi-window display. This enhances user's convenience.

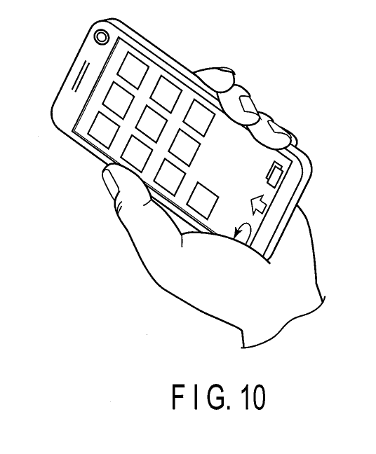

Although in the above embodiment, the “history of applications recently used” is used when the multi-window mode is launched from the home screen, two applications may be activated based on the multi-window history. Further, although the embodiment employs, as an electronic device example, a monitor device connected to a smartphone, it may employ a smartphone or tablet PC itself, or a PC with a keyboard and a mouse instead of the touch display. FIG. 10 shows an example of the smartphone.

Moreover, the processing performed in the embodiment can be realized by a computer program. Therefore, the same advantage as that of the embodiment can be easily obtained by installing the computer program in a computer through a computer-readable recording medium storing the computer program.

The present invention is not limited to the above-described embodiment, but may be modified in various ways without departing from the scope. Various inventions can be realized by appropriately combining the structural elements disclosed in the embodiment. For instance, some of the disclosed structural elements may be deleted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The present embodiments can realize the following devices:

(1) An electronic device capable of activating applications and displaying the applications in a multi-window mode, including:

a memory configured to store a history of the applications displayed in the multi-window mode;

a controller configured to activate a first application and a second application based on the history stored in the memory, upon receiving an activation trigger; and

a display configured to display windows for the first and second applications in a first area and a second area obtained by dividing a screen.

(2) The electronic device according to (1), wherein

the display processor also displays the history of the applications stored in the memory;

the controller activates a third application selected from the displayed history; and

the display displays a window for the third application in the first or second area, instead of the window for the first or second application.

(3) The electronic device according to (2), wherein the controller assigns a right of operation to the window for the third application.

(4) The electronic device according to (1), wherein the controller assigns a right of operation to the application window displayed in the first area.

(5) The electronic device according to (1), wherein the controller activates the first and second applications upon receiving an activation trigger in a state in which no application is activated.

(6) The electronic device according to (1), wherein the display also displays an indicator indicating an area to which a right of operation is assigned, and exchanges the windows displayed in the first and second regions when the indicator is selected.

(7) The electronic device according to (1), wherein

the indicator includes a first icon indicating the first area, and a second icon indicating the second area; and

the first icon is highlighted when the first area has a right of operation, and the second icon is highlighted when the second area has the right of operation.

(8) An electronic device including:

a controller configured to activate a second application upon receiving an activation trigger for activation of the second application during activation of a first application; and

a display configured to display windows for the first and second applications in a first area and a second area of a screen.

(9) The electronic device according to (8), further including a memory configured to store a history of applications displayed in a multi-window mode,

wherein

the display also displays the history of the applications stored in the memory;

the controller activates a third application selected from the displayed history; and

the display displays a window for the third application in the first or second area, instead of the window for the first or second application.

(10) The electronic device according to (9), wherein the controller assigns a right of operation to the window for the third application.

(11) The electronic device according to (8), wherein the controller assigns a right of operation to the application window displayed in the first area.

(12) The electronic device according to (8), wherein the controller activates the first and second applications upon receiving an activation trigger in a state in which no application is activated.

(13) The electronic device according to (8), wherein the display also displays an indicator indicating an area to which a right of operation is assigned, and exchanges the windows displayed in the first and second regions when the indicator is selected.

(14) The electronic device according to (8), wherein

the indicator includes a first icon indicating the first area, and a second icon indicating the second area; and

the first icon is highlighted when the first area has a right of operation, and the second icon is highlighted when the second area has the right of operation.

(15) The electronic device according to (8), wherein the display displays a selection screen as to whether a multi-window display is to be performed; displays the windows for the first and second applications in the first and second areas when the multi-window display is selected; and displays the window for the second application on the full screen when the multi-window display is not selected.

(16) A method for use in an electronic device capable of activating applications and displaying the applications in a multi-window mode, including:

storing a history of the applications displayed in the multi-window mode;

activating a first application and a second application based on the stored history, upon receiving an activation trigger; and

displaying windows for the first and second applications in a first area and a second area of a screen.

(17) The method according to (16), wherein

the displaying also includes displaying the stored history of the applications;

the activating includes activating a third application selected from the displayed history; and

the displaying includes displaying a window for the third application in the first or second area, instead of the window for the first or second application.

(18) The method according to (17), further including assigning a right of operation to the window for the third application.

(19) The method according to (16), further including assigning a right of operation to the application window displayed in the first area.

(20) The method according to (16), wherein the activating includes activating the first and second applications upon receiving an activation trigger in a state in which no application is activated.

(21) The method according to (16), wherein the displaying includes displaying an indicator indicating an area to which a right of operation is assigned, and exchanging the windows displayed in the first and second regions when the indicator is selected.

(22) The method according to (16), wherein the indicator includes a first icon indicating the first area, and a second icon indicating the second area,

further including:

highlighting the first icon when the first area has a right of operation; and

highlighting the second icon when the second area has the right of operation.

(23) A method including:

activating a second application upon receiving an activation trigger for activation of the second application during activation of a first application; and

displaying windows for the first and second applications in a first area and a second area of a screen.

(24) The method according to (23), further including storing a history of applications displayed in a multi-window mode,

wherein

the displaying also includes displaying the stored history of the applications;

the activating includes activating a third application selected from the displayed history; and

the displaying includes displaying a window for the third application in the first or second area, instead of the window for the first or second application.

(25) The method according to (24), further including assigning a right of operation to the window for the third application.

(26) The method according to (23), further including assigning a right of operation to the application window displayed in the first area.

(27) The method according to (23), wherein the activating comprises activating the first and second applications upon receiving an activation trigger in a state in which no application is activated.

(28) The method according to (23), wherein the displaying includes displaying an indicator indicating an area to which a right of operation is assigned, and exchanging the windows displayed in the first and second regions when the indicator is selected.

(29) The method according to (23), wherein the indicator includes a first icon indicating the first area, and a second icon indicating the second area,

further including:

highlighting the first icon when the first area has a right of operation; and

highlighting the second icon when the second area has the right of operation.

(30) The method according to (23), wherein the displaying includes:

displaying a selection screen as to whether a multi-window display is to be performed;

displaying the windows for the first and second applications in the first and second areas when the multi-window display is selected; and

displaying the window for the second application on the full screen when the multi-window display is not selected.

(31) A non-transitory, computer readable medium including computer executable instructions, wherein the instructions, when executed by a processor, cause the processor to perform a method including:

storing a history of applications displayed in a multi-window mode;

activating a first application and a second application based on the stored history, upon receiving an activation trigger; and

displaying windows for the first and second applications in a first area and a second area of a screen.

(32) A non-transitory, computer readable medium including computer executable instructions, wherein the instructions, when executed by a processor, cause the processor to perform a method including:

activating a second application upon receiving an activation trigger for activation of the second application during activation of a first application; and

displaying windows for the first and second applications in a first area and a second area of a screen.

What is claimed is:

1. An electronic device capable of activating applications and displaying the applications in a multi-window mode, the device comprising:
a memory configured to store a history of the applications displayed in the multi-window mode;
a controller configured to activate a first application and a second application based on the history stored in the memory, upon receiving an activation trigger; and
a display configured to display windows for the first and second applications in a first area and a second area of a screen.

2. The electronic device of claim 1, wherein the display is further configured to display the history of the applications stored in the memory;
the controller is configured to activate a third application selected from the displayed history; and
the display is configured to display a window for the third application in the first or second area, instead of the window for the first or second application.

3. The electronic device of claim 2, wherein the controller is configured to assign a right of operation to the window for the third application.

4. The electronic device of claim 1, wherein the controller is configured to assign a right of operation to one of the windows that is displayed in the first area.

5. The electronic device of claim 1, wherein the controller is configured to activate the first and second applications upon receiving the activation trigger in a state in which no application is activated.

6. The electronic device of claim 1, wherein the display is configured to display an indicator indicative of an area to which a right of operation is assigned, and to exchange the windows displayed in the first and second regions when the indicator is selected.

7. The electronic device of claim 1, wherein the indicator comprises a first icon indicative of the first area, and a second icon indicative of the second area; and
the first icon is highlighted when the first area is assigned a right of operation, and the second icon is highlighted when the second area is assigned the right of operation.

8. An electronic device comprising:
a controller configured to activate a second application upon receiving an activation trigger for activation of the second application during activation of a first application; and
a display configured to display windows for the first and second applications in a first area and a second area of a screen.

9. A method for use in an electronic device capable of activating applications and displaying the applications in a multi-window mode, the method comprising:
storing a history of the applications displayed in the multi-window mode;
activating a first application and a second application based on the stored history, upon receiving an activation trigger; and
displaying windows for the first and second applications in a first area and a second area of a screen.

10. A non-transitory, computer-readable storage medium having stored thereon a computer program which is executable by a computer, the computer program controlling the computer to execute functions of:
storing a history of applications displayed in a multi-window mode;
activating a first application and a second application based on the stored history, upon receiving an activation trigger; and
displaying windows for the first and second applications in a first area and a second area of a screen.

11. A non-transitory, computer-readable storage medium having stored thereon a computer program which is executable by a computer, the computer program controlling the computer to execute functions of:
activating a second application upon receiving an activation trigger for activation of the second application during activation of a first application; and
displaying windows for the first and second applications in a first area and a second area of a screen.
